(19) United States
(12) Patent Application Publication
(10) Pub. No.: US 2013/0277288 A1
(43) Pub. Date: Oct. 24, 2013

(54) WELL-WATER TREATMENT SYSTEM

(71) Applicant: AQUA IP, Auburn, WA (US)

(72) Inventors: Scott Borough, Renton, WA (US); Larry Meek, Renton, WA (US); Laren Meek, Renton, WA (US)

(73) Assignee: AQUA IP, Auburn, WA (US)

(21) Appl. No.: 13/868,672

(22) Filed: Apr. 23, 2013

Related U.S. Application Data
(60) Provisional application No. 61/636,990, filed on Apr. 23, 2012.

(51) Int. Cl. C02F 1/00; C02F 1/74

(52) U.S. Cl. CPC C02F 1/004; C02F 1/74
USPC 210/97; 210/258

(57) ABSTRACT

The current application is directed to cost-effective and efficient well-water treatment systems that employ both multi-layer filtration and aeration to remove undesirable gasses, such as carbon dioxide, hydrogen sulfide, methane, radon, and volatile organic-compound gasses from input well water as well as particulate contaminants and soluble metal ions, including iron and manganese. The well-water treatment systems to which the current application is directed additionally remove many other types of well-water contaminants.

### CROSS-REFERENCE TO RELATED APPLICATION

This application claims the benefit of Provisional Application No. 61/636,990, filed Apr. 23, 2012.

### TECHNICAL FIELD

The current application is directed to a system for cleaning input well water of various types of contaminants prior to distribution within internal water-supply lines of residential and commercial buildings.

### BACKGROUND

Well over 15 million US households depend on private ground-water wells for water supply. Well water, however, may be contaminated with many different types of contaminants, including bacteria and other microorganisms from septic systems and agricultural runoff, iron, manganese, and other natural soluble and particulate metal contaminants, various gasses, including hydrogen sulfide, carbon dioxide, methane, come complex hydrocarbon gasses, and radon, either from natural sources or resulting from mining operations, oil and gas recovery, and other human activities, volatile organic compounds from industrial and agricultural runoff, pesticides from agricultural runoff and other sources, and many additional types of contaminants. At high concentrations, contaminants may lead to deleterious health effects for those who depend on well water for drinking, cooking, and bathing. At lower concentrations, contaminants may render well water disagreeable or unpotable, and they may also result in corrosion, clogging, and abrasion damage to internal plumbing and water-using appliances.

Many different types of water-cleaning systems are employed currently, both for public-utility-supplied water as well as for private well water. However, many of the well-water-cleaning systems that are currently available are expensive, often costing in excess of $15,000, are often inefficient and even ineffective for various types of contaminants, and may introduce corrosive contaminants into water in the process of removing other types of contaminants, such as soluble metal ions. Additionally, many currently available water-cleaning systems require frequent and expensive maintenance and may decrease the flow rate and water pressure within internal water-supply lines. For all of these reasons, home and commercial-building owners, building managers, and other users of well water continue to seek cost-effective systems for cleaning a broad range of contaminants from well water.

### SUMMARY

The current application is directed to cost-effective and efficient well-water treatment systems that employ both multi-layer filtration and aeration to remove undesirable gasses, such as carbon dioxide, hydrogen sulfide, methane, radon, and volatile organic-compound gasses from input well water as well as particulate contaminants and soluble metal ions, including iron and manganese. The well-water treatment systems to which the current application is directed additionally remove many other types of well-water contaminants.

### BRIEF DESCRIPTION OF THE DRAWINGS

FIG. 1 provides an overview of a well-water treatment system that is an example of the well-water treatment systems to which the current application is directed.

FIG. 2 shows an exploded-view diagram of one example of the well-cleaning system to which the current application is directed.

FIG. 3 illustrates a pleated internal mass-transfer-tube member used in certain examples of the well-cleaning system to which the current application is directed.

FIG. 4 illustrates the pleated, internal mass-transfer-tube member 302 positioned within the mass-transfer tube 104.

### DETAILED DESCRIPTION

The current application is directed to efficient and cost-effective well-water treatment systems that remove gaseous, soluble, and particulate contaminants from well water used to supply drinking water, cooking water, bathing and shower water, and water for various different types of appliances to residential and commercial buildings. The well-water treatment systems to which the current application is directed employ both aeration and filtering to remove contaminants.

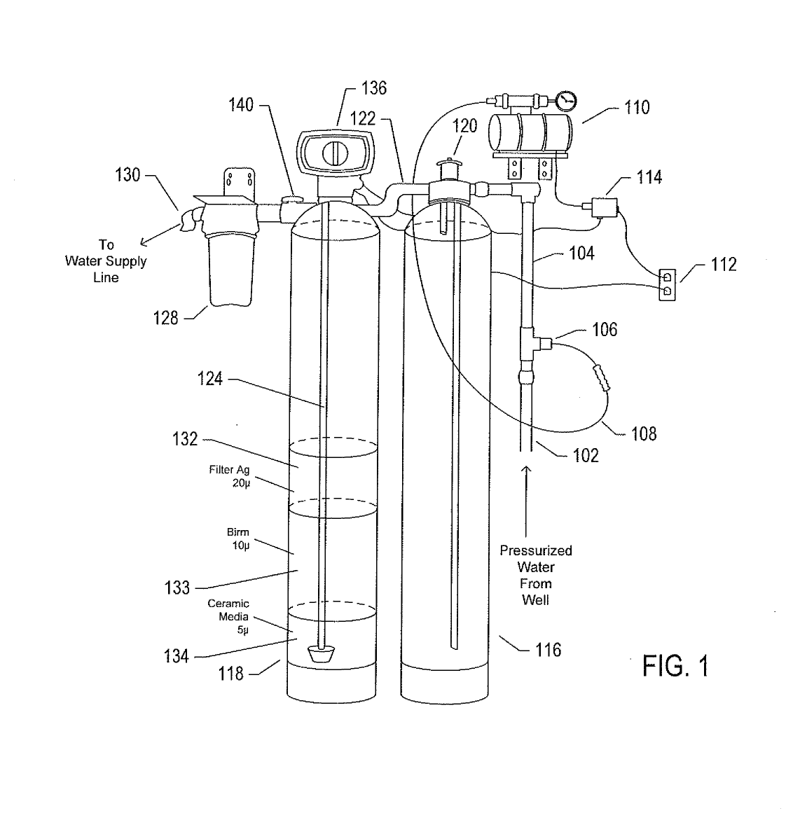

FIG. 1 provides an overview of a well-water treatment system that is an example of the well-water treatment systems to which the current application is directed. Pressurized water is received by the system from a pump that pumps water from a well into input pipe 102. The input water passes into a mass-transfer tube 104, into which pressurized air is introduced 106 from a pressurized-air supply tube 108 that interconnects the mass-transfer tube with an electric air pump 110. The electric air pump is supplied with electricity from a wall socket 112 via an electronic switch 114. The mass-transfer tube is described, in greater detail, below. The input, pressurized well water is aerated in the mass-transfer tube, and the aerated water then passes into a first aeration tank.

Air introduced into the well water within the mass-transfer tube 104, under pressure, is slowly released from the water within the aeration tank, along with gaseous contaminants, including volatile organic compounds, methane, carbon dioxide, hydrogen sulfide, radon, and other gaseous contaminants. Both the contaminants and excess air are released from the air head 120 through air vent 121 at the top of the aeration tank 116. Water is drawn, by internal demand, such as by opening a water faucet with the building supplied from the well-water treatment system, from the aeration tank into the filtration tank 118 through pipe 122. The pressurized water is forced through filtration layers 132-134 and then up through tube 124, from which the filtered water flows out to pipe 126. The filtered water is then input into a final, downstream canister-type filter 128 from which the water enters a water supply line 130 that supplies water to internal plumbing within the residence or commercial building supplied from the well-water treatment system. The filtration tank includes layers 132-134 of three different filter media. Layer 132 comprises, in one example, filter Ag, a non-hydrous silicon-dioxide material, with a density of approximately 25 pounds per cubic foot, that filters particles down to a diameter of 20 μm. The second layer 133 comprises a Birm filter medium, an aluminum silicate material, with a density of approximately 40 pounds per cubic foot, that filters particles down to a diameter of 10 μm. A final layer 134 comprises a porous ceramic filter medium, with a density of approximately 70 pounds per cubic foot, that filters particles down to a diameter of 5 μm. Backwash operations can be employed to clean the filter-media layers, after which the filter layers naturally reform, as shown in FIG. 1, due to the different densities and sizes of the different types of media particles. In one example, water is first filtered by the coarse filter material in the first layer 132, next by the finer filter material in the second layer 133, and finally by the very fine filter material in the final layer 134. By this method, suspended particles are removed throughout the filter layers, rather than in a first thin sublayer at the top of the filter medium, as in many currently used systems. A different number of layers and different types of filter material may be employed, in alternative examples, for the well-water treatment systems to which the current application is directed. The final canister filter 128 can have any of many different designs, and may include various different types of filtering media and elements, including activated charcoal, metal complexes embedded in porous materials, and 3D-network-material-based filters. Such filters can be used to remove chlorine, metal ions, soluble organics, and other contaminants in the water and may also have anti-microbial properties. A main control head 136 connected to the top of the filtration tank 118 provides for control of the flow of pressurized water from the well into input pipe 102 as well as a flow control within the well-water treatment system. In addition, the main control head provides control for automated or manually activated backwash operations to periodically clean the filter media. The main control head may additionally include a variety of sensors and control components to monitor and adjust operation of various components of the well-water treatment system and generate information and warning signals.

One feature of the well-water treatment systems to which the current application is directed is that approximately equal-sized aeration and filtration pressure tanks are employed. In currently available well-water treatment systems that employ aeration tanks, the aeration tank is often significantly smaller, in volume, than the filtration tank or other system reservoirs. Employing the larger aeration tank in the currently described systems ensures that air introduced into the water within the mass-transfer tube is released sufficiently slowly to allow the dissolved air to act catalytically and as an oxidant while removing various contaminants but, at the same time, allows venting of removed gaseous contaminants and excess dissolved air that may otherwise result in increased corrosion within internal building water-supply lines and water-using appliances. The air introduced under pressure in the mass-transfer tube also precipitates certain dissolved minerals from the well water, including iron and manganese. The mass-transfer tube, described in greater detail below, is effective in increasing the amount of air mixed with the water and dissolved into the water by increasing the surface area of the air introduced into the water as well as by creating significant amounts of turbulence in the flowing water that assists in mixing, suspending, and dissolving air.

The well-water treatment system illustrated in FIG. 1 additionally includes a flow switch 140 which controls powering on and powering off the air pump 110. The flow switch 140 senses flowing water and activates the air pump 110 when water is flowing from the filtration tank 118 into the final canister filter 128.

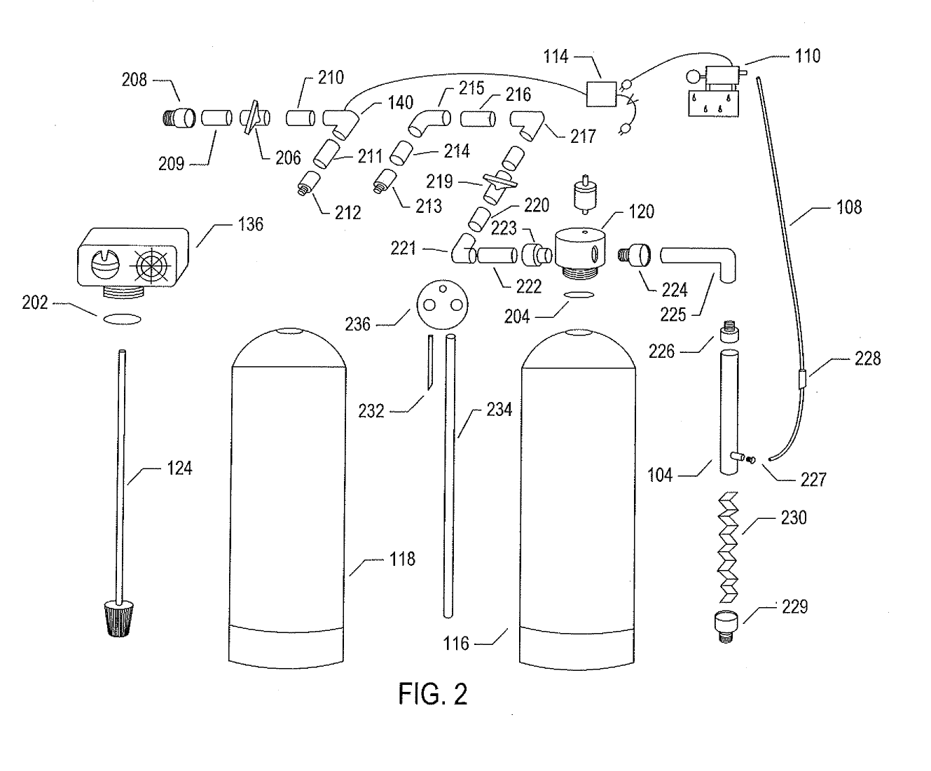

FIG. 2 shows an exploded-view diagram of one example of the well-cleaning system to which the current application is directed. Many of the individual pieces and parts shown in FIG. 2 are described above, with reference to FIG. 1. For the sake of economy in description, the numeric labels used in FIG. 1 are again applied to the corresponding components in FIG. 2. In FIG. 2, additional details, including O-rings 202 and 204, a flow-switch ball-valve assembly 206, various fittings and pipe components 208-229, a pleated internal mass-transfer-tube member 230, an internal air tube 232, and air distributor tube 234 that attach to the air-head bottom 236 that are located within the aeration tank 116 are additionally shown. In the various different examples of the well-cleaning system to which the current application is directed, various different types, sizes, and constellations of fittings, pipe members, and other components fashioned from various different types of materials may alternatively be used.

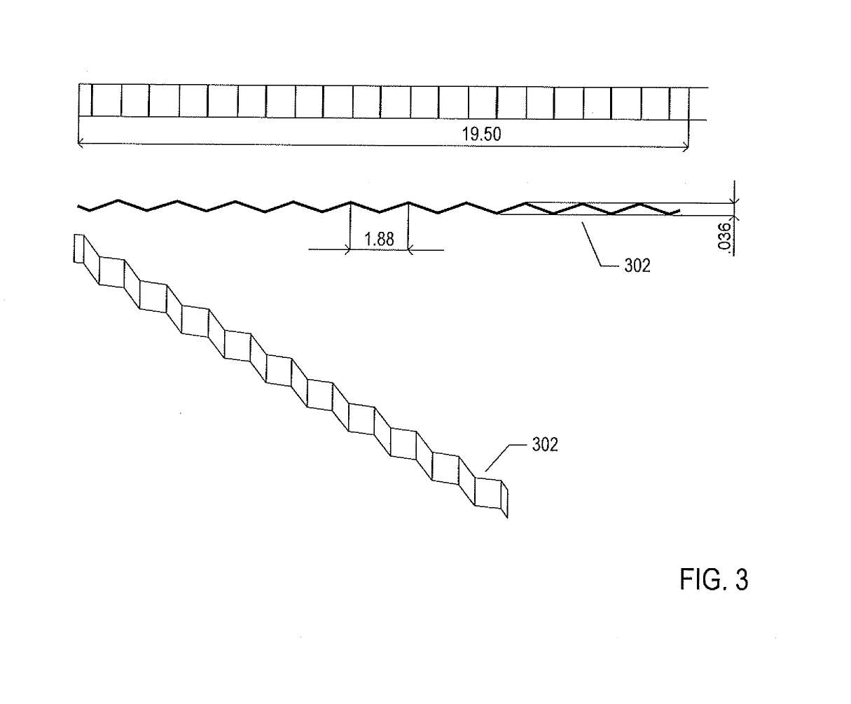

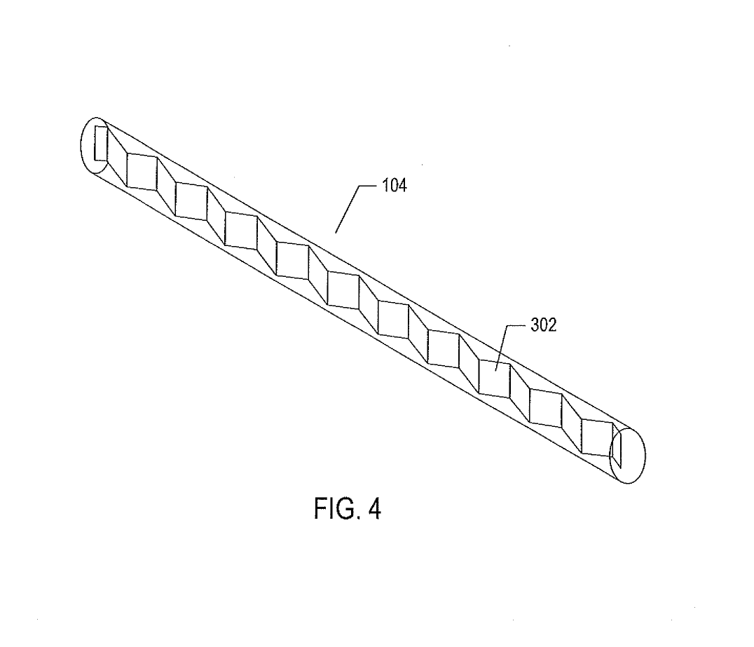

FIG. 3 illustrates the pleated internal mass-transfer-tube member used in certain examples of the well-cleaning system to which the current application is directed. The pleated internal mass-transfer tube member 302 is a narrow, rigid, pleated food grade, polymeric material, or other material that induces turbulence and back currents in well water flowing through the mass-transfer tube that facilitate aeration of the well water by mixing tiny, frothy bubbles of air thoroughly within the well water, much like turbulence of streams result in aeration of water in creeks and streams. FIG. 4 illustrates the pleated, internal mass-transfer-tube member 302 positioned within the mass-transfer tube 104.

Table 1, provided below, provides characteristics and specifications for one example well-water-cleaning system to which the current application is directed.

TABLE 1
System Specifications

| | |
|---|---|
| System Function | Removal of Iron, Manganese, |
| | Hydrogen Sulfide, & VOC's |
| Dimensions | (2) 10″ × 54″ tanks |
| | (Aeration Tank & Media Tank) |
| Flow Rate for Backwash | 5 |
| (gpm) | |
| Effective Flow Rate (gpm) | 15 |
| Maximum Removal | 15 ppm Iron, 3 ppm Manganese, |
| Capabilities | 7 ppm Hydrogen Sulfide |
| Max Pressure | 100 psi |
| Min Pressure | 30 psi |
| pH Level | 6.0 to 8.5 |
| Plumbing Inlet/Outlet Size | 1″ |
| Mass Transfer Tube | 22″ |
| Length | |
| Flow Switch Included | Yes |

Although the present invention has been described in terms of particular embodiments, it is not intended that the invention be limited to these embodiments. Modifications within the spirit of the invention will be apparent to those skilled in the art. For example, as discussed above, various components and groups of components within the above-described well-water-cleaning system may be altered in material composition and dimensions, and alternative subcomponents may be substituted for the described subcomponents and various alternative examples of the well-water-cleaning system to which the current application is directed. Additional and/or different types of layers of filter media may be employed within the filtration tank as another example of possible alternatives to the above-described well-water-cleaning system. Many additional control features may be added to facilitate monitoring, and notification of events warranting attention from users may be included in alternative examples.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A well-water treatment system comprising:
an input pipe that receives pumped well water;
a mass-transfer tube, connected to the input pipe, that receives pumped well water from the input pipe and pressurized air from an air pump and that outputs aerated water through a first internal pipe to an aeration tank;
an aeration tank that stores aerated water received from the mass-transfer tube, allowing gaseous contaminants and excess air to vent to the external environment;
a filtration tank that receives aerated water from the aeration tank, the received water passing through internal layers of filtration media before being output to a second internal pipe through a final filter to an internal water-supply line of a residence or commercial building.

2. The well-water treatment system of claim 1 further including a main control head fitted to the filtration tank, which controls intermittent backwash filter-media-cleaning operations and flow rates within the well-water treatment system.

3. The well-water treatment system of claim 1 further including a flow switch within the second internal pipe that, upon sensing water flow, controls an electronic switch to power on the air pump.

4. The well-water treatment system of claim 1 wherein the final filter is a canister-type water filter.

5. The well-water treatment system of claim 1 wherein the filtration tank includes three filter-media layers that naturally form by sedimentation within the filtration pressure tank dues to different particle sizes and densities of the filter media.

6. The well-water treatment system of claim 5 wherein the three layers include:
a first layer comprising a non-hydrous silicon-dioxide material with a density of approximately 25 pounds per cubic foot;
a second layer comprising an aluminum silicate material with a density of approximately 40 pounds per cubic foot; and
a third layer comprising a porous ceramic material with a density of approximately 70 pounds per cubic foot.

7. The well-water treatment system of claim 1 wherein the mass-transfer tube includes a pleated, internal mass-transfer-tube member that introduces turbulent and counter-current flows within the mass-transfer tube when water flows through the mass-transfer tube.
